(19) United States
(12) Patent Application Publication
(10) Pub. No.: US 2020/0004213 A1
(43) Pub. Date: Jan. 2, 2020

(54) INTERACTIVE BUILDING MANAGEMENT SYSTEM

(71) Applicant: CARLORATTIASSOCIATI S.R.L., Torino (IT)

(72) Inventor: CARLO FILIPPO RATTI, TORINO (IT)

(21) Appl. No.: 16/493,347

(22) PCT Filed: Mar. 13, 2018
(86) PCT No.: PCT/IB2018/051654

§ 371 Date: Sep. 12, 2019

(30) Foreign Application Priority Data
Mar. 14, 2017 (IT) 102017000027819

(51) Int. Cl. G05B 15/02; G06Q 10/02

(52) U.S. Cl. CPC G05B 15/02; G06Q 10/02

(57) ABSTRACT

An interactive building management system comprises a system for determining the position of individuals within the building, a user interface system arranged to acquire requests for customization of the functions of the building from individuals, a database system of individuals located within the building, a control system of the building functions, and a processing system arranged to receive positioning data of individuals and customization requests of at least one function of the building by individuals, connect to the database system and acquire positioning data of individuals who frequent the building as a function of time and a history of requests for customization of the building functions by the individuals as a function of time, and transmit to the control system building function control programs according to the history of customization requests, or building function control signals according to the immediate customization requests received from the individuals who frequent the building.

The present invention relates in general to home automation and more specifically to building management systems.

Building management systems or building automation systems are automatic control systems based on the use of one or more programmed computers, adapted to monitor and control the mechanical and electrical equipment installed in a building for the management of environmental control functions of the same building. Typically, such systems act on the basis of preset programs and timings, regardless of the occupation of the building environments by individuals frequenting them (occupants or visitors).

Building management systems are known which are adapted to detect the presence of individuals who access the building and visit predetermined environments, as well as the occupation of environments or individual workstations inside the building, in order to automatically control the activation and deactivation of actuator devices installed in the building, such as air conditioners and lighting systems, to improve the efficiency of the environmental control of the same building. Typically, these systems control actuator devices independently of one another with related control software and hardware.

The object of the present invention is to provide an improved, real time building management system in order to optimize the control of the environments of the building, i.e. the use of actuator devices installed in the building, as well as the occupation of environments of the building, in a flexible and real-time way, optimizing the running costs of the building itself.

According to the present invention, this object is achieved by means of a system having the features claimed in claim 1.

Particular embodiments are the subject of the dependent claims, the content of which is to be understood as an integral part of the present description.

In summary, the present invention relates to an interactive building management system based on the principle of controlling the management of buildings through the positioning and identification of individuals who access the buildings and specific environments thereof and the acquisition of specific requests for control of functions and/or environments of the building by said individuals (who are also users of the system of the invention), for example, in the form of adjustment parameters (and activation/deactivation) of actuator devices installed in the building.

Advantageously, the acquisition of requests for control of building functions takes place through an interface system comprising a computer data collection and processing environment implemented as a software application residing on a personal electronic device, such as, for example, a mobile communication device, associated with an individual who frequents the building.

The aforesaid personal electronic device is furthermore arranged to interact with a positioning system and programmed to broadcast an identification signal receivable by at least one receiver of the positioning system, said positioning system being adapted to detect the arrival angle of said broadcast identification signal and to determine therefrom, and based on the predetermined position of said at least one receiver on a building map, a positioning coordinate of said personal device in such a way as to indirectly acquire information on the position of an individual who frequents the building.

Advantageously, due to the integration of the technologies described above, the management system of the invention is not only a programmable automated management system, but rather an adaptive system, which may respond in real time to the real needs of the individuals who frequent a building. For example, with reference to the air conditioning of the building, a management system according to the invention allows real-time responsive air conditioning to be implemented in the presence of individuals in the building environments, allowing individuals to take control of the air conditioning in the environment where they are located or where they are intending to be located to ensure customized comfort, improving the efficiency of the building management system on the basis of the actual presence (occupation) in the environments thereof.

The system of the invention advantageously allows independent systems of the building to be interconnected with the knowledge of the real-time occupation of the building environments in such a way as to implement a system capable of recording and constantly self-learning the preferences of the individuals who frequent the building and predicting future control configurations of building functions.

A particular feature of the system of the invention is that of using a user-oriented positioning system, that is, aimed at always tracking the position of individuals in the building, unlike machine-oriented or function-oriented positioning systems, i.e., those that detect the presence of individuals in the building only in the areas or locations that they may frequent.

This structural difference also has consequences from a functional point of view: the system of the invention is adapted to record historical data (and calculate statistical data) of the presence of individuals within the building and of the interaction of individuals with the occupied areas or workstations (requests for configuration of the functions associated with said areas or workstations, i.e. activation, adjustment, deactivation of actuator devices installed in the building, in general, control of the building environments) to recognize behavioral patterns that may be associated with each individual and to make predictions of use of areas and functions of the building, as well as design changes to building areas or changes of installation of devices in the building.

Further features and advantages of the invention will be described in greater detail in the following detailed description of one embodiment thereof, given by way of non-limiting example, with reference to the accompanying drawings wherein:

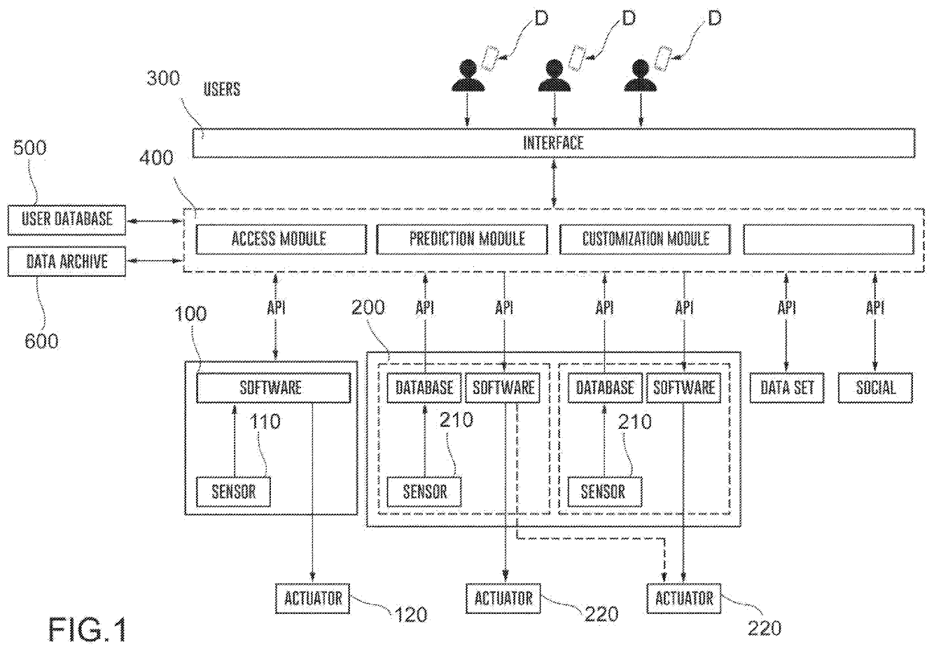

FIG. 1 is an illustrative diagram of the architecture of the system of the invention;

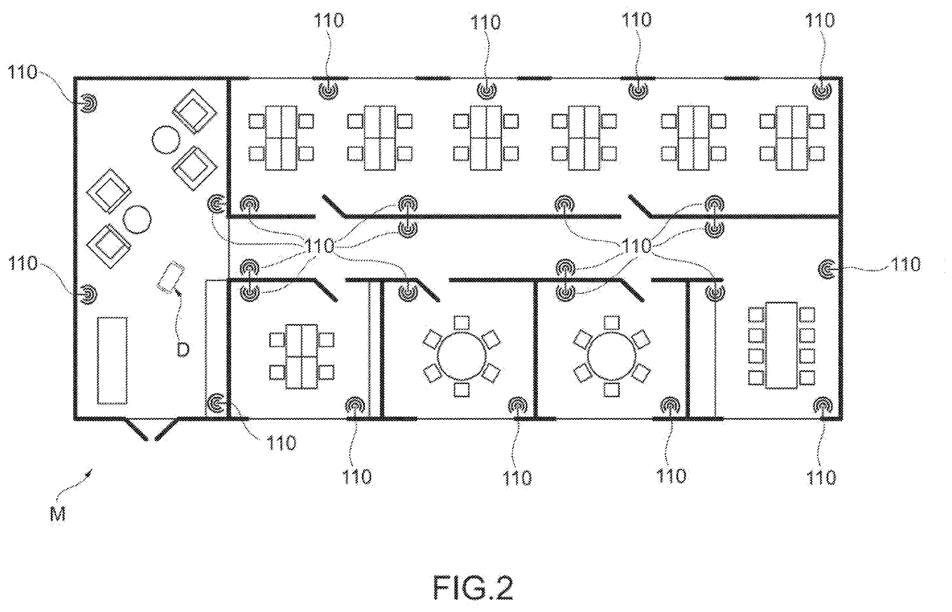

FIG. 2 is an illustrative representation of a positioning system according to the present invention;

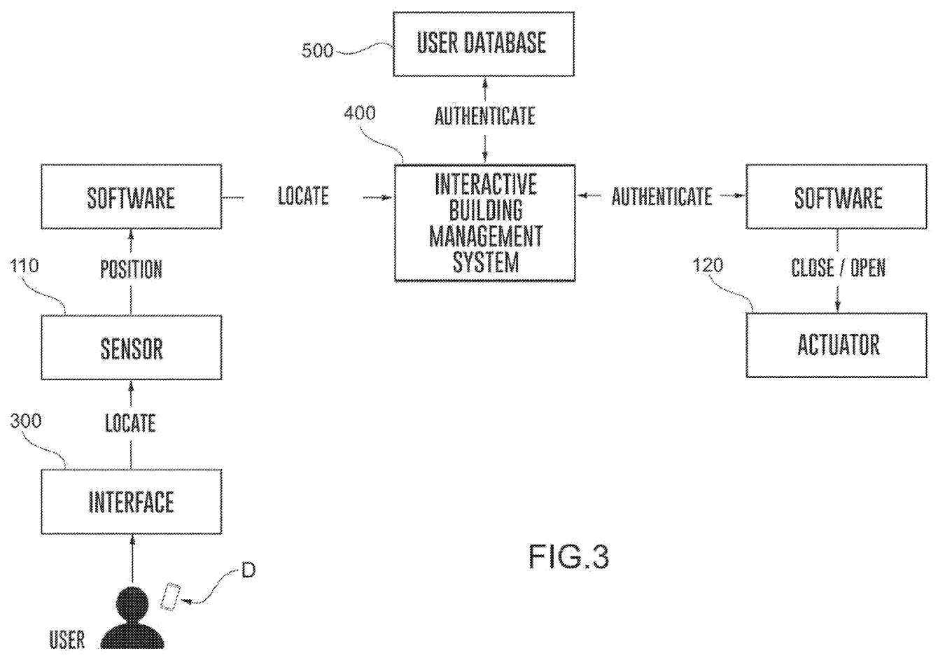

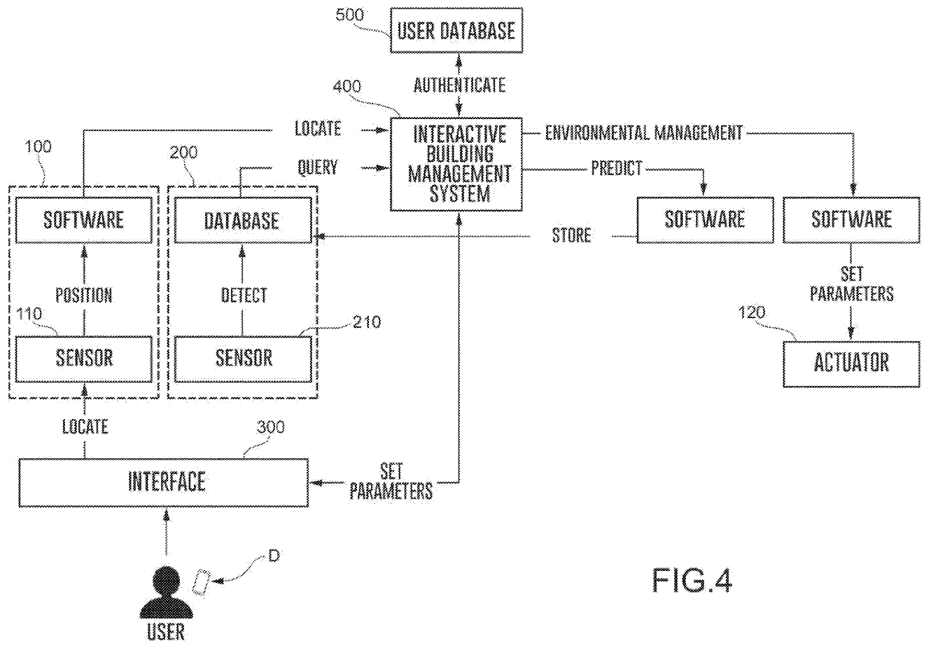

FIGS. 3 and 4 are diagrams representative of the flow of operations in the system of the invention, respectively for the access of an individual/user of the system and for the control of the environments of a building.

In the figures, identical or functionally equivalent elements or components have been indicated with the same references.

FIG. 1 shows an interactive building management system according to the invention, indicated collectively at S.

The system is based on the interaction of three main components:
a positioning system 100, arranged to detect the presence of individuals and their position within a building or area of buildings, comprising a plurality of Bluetooth low energy receivers 110, optionally associated with access gates and related actuators 120, adapted to receive at least one identification signal from a personal portable electronic device, such as a mobile communication device D, associated with an individual who frequents the building. Said receivers are moreover adapted to determine the arrival angle of the received identification signal and arranged to transmit data representative of said identification signal of the mobile device D and of the related arrival angle—and possibly an own identifier or similar position information on a default building map—to a centralized positioning engine, for example, residing on a building central server or on a remote server (cloud server), arranged to determine the position of the mobile device D and the associated user on said default building map on the basis of data transmitted by one or more receivers, in particular, to identify the position of the mobile device in a building environment or in proximity to an access or communication gate between building environments based on recognition of the direction of the signal received, for example, with an accuracy on the order of twenty centimeters, allowing the positioning of individuals having their personal device with them;
a building function control system 200, optionally associated with one or more environmental sensors 210 installed in the building, arranged to control a plurality of actuators 220 arranged in different environments of the building, comprising one or more electronic processing and control units associated with each building function performed by mechanical or electrical equipment of the building or by groups of equipment for the monitoring and automatic control of the same;
a user interface system 300 comprising a computer data collection and processing environment implemented as a software application residing on a personal portable electronic device, such as a mobile communication device D, associated with an individual who frequents the building, such device being adapted to receive positioning data from said positioning engine and is arranged to acquire requests to customize the building functions from individuals located in the building.

The system further comprises processing means 400 adapted to receive positioning data of an individual frequenting the building through the positioning engine, environmental sensing data if any through the use of said environmental sensors 210 installed in the building, customization requests of at least one function of the building by an individual located in the building as well as identification data of individuals frequenting the building from a database system of individuals 500, 600—arranged to store time data on the presence of individuals frequenting the building (500) and a history of requests for customization of the building functions by said individuals (600)—the processing means 400 being arranged to automatically control the actuators 220 through the respective electronic processing and control units.

With reference to FIG. 2, the Bluetooth low energy receivers 110 are installed, for example in a uniformly distributed manner, in the building to form a seamless coverage network. The figure shows an illustrative layout of a building comprising a plurality of environments separated from each other by walls and connected through gates. On the layout there is identified a plurality of receivers 110, by way of example arranged in a substantially regular manner within the separate individual environments of the building, in order to cover the entire area of the building. For this reason, the receivers 110 are arranged also taking into account the presence of walls or partitions between environments that could disturb the signal emitted by programmed mobile devices in the vicinity, and in proximity to gates.

The personal portable electronic devices of the individuals are programmed to broadcast said identification signal according to a predetermined radio signaling packet, for example, on command of a user or when the device is located within a predetermined area. Advantageously, the mobile device D is a mobile telephone, since an individual always carries it, even during brief displacements.

This allows the user interface system to perform actions when the personal devices are located in the vicinity of a receiver.

Using the user interface system 300—which implements an interface between the individual, the positioning system 100, the building function control system 200 and the processing means 400—an individual may execute a predetermined set of actions, in particular, actions to control the building functions (implemented by mechanical or electrical equipment installed in the building), when the individual is in a building or in an area of buildings equipped with the management system of the invention.

More specifically, the user interface system 300 offers to an individual user of the building management system of the invention the following functions:
registration on the building management system;
access to and booking of facilities or services (functions) of the building, for example bookings for computerized workstations, meeting rooms, workstations, or bookings for participations in events;
sharing of building functions with other individuals in a same environment;
tracking over time the position of the individual inside the building or in proximity thereof, by detecting the presence of a mobile device D programmed through the receivers 110;
the consent to access areas of the building to reach a structure or to use a booked service, when the individual is in the proximity of a controlled access gate;
the monitoring and control, also remotely and for future times, of the temperature, air conditioning and lighting in the environment where the individual goes or where the individual is located (which may be a closed space of the building or a workstation in a shared open space).

The system of the invention also allows a building control operator to control the flow of individuals within the building, to associate an individual with a behavior in terms of social interaction and control of the building's functions, and to predict an individual's future behavior or future way of using a building's functions.

Based on the input data received from the interface system—for example via a Wi-Fi connection or a Bluetooth connection—the building management system of the invention may calculate data representative of the individuals frequenting the building, their actions and their behavior as reflected on the building's functions, and react automatically in real time through a series of actions, such as:
allow or deny to certain individuals access to predetermined structures within the building on the basis of specific access times and/or access authorizations that may be manually set by a building operator;
operate air conditioning systems, lighting systems and other environmental control systems according to each setting desired by an individual, save the preferences of desired settings and the locations over time of an individual in the building;
whenever more than one individual is present in the same environment and a plurality of individuals request a modification of a function of the same area, calculate a mean value of the parameter to be modified, for example temperature, ventilation, lighting, the time of occupation of a resource, resulting from the request of different individuals and implement the relative conditioning and lighting systems and other environmental control units consistently with the average value of the respective calculated parameter;
monitor the frequenting of areas of a building by individuals, the consumption of energy inside the building, the temperature, the ventilation and the lighting of the building areas at all times;
provide a continuous, real-time representation of all the data received and of the current occupation condition of the building areas;
generate predictions based on the history of the data collected with respect to the amount of energy requested for future times to adapt to the detected modes of use of the building over time and consequently to activate the air conditioning, lighting and other environmental control systems according to the typical behavior of individuals who frequent the building even before they set a desired value.

FIG. 3 shows a flow of operations for the access of an individual/user of the system to a building wherein an individual, through the interface system 300 residing on his/her own personal electronic device, such as his/her own mobile communication device D, carries out a process of locating his/her own position through one or more receivers 110 of the positioning system 100 in proximity to an access gate of the building. The recognized position of the individual is transmitted, through control software, to the processing means 400 of the system, which authenticate the individual after consulting the database 500 and then, by means of control software, authorize (or deny) access to the building by controlling an actuator 120 associated with the access gate.

Finally, FIG. 4 shows a flow of operations for controlling an environment of the building by an individual located in the building itself.

An individual, through the interface system 300 residing on his/her own personal electronic device, such as his/her own mobile communication device D, carries out a process of locating his/her own position through one or more receivers 110 of the positioning system 100. The recognized position of the individual is transmitted, through control software, to the processing means 400 of the system, which authenticate the individual after consulting the database 500. At the same time, at least one environmental sensor 210 of a building function control system 200 transmits detected data relating to a building function to a database of the building function control system which stores a prediction of a control configuration of the aforementioned building function executed by the processing means 400 and received by means of control software. The individual, by means of the interface 300, transmits a request, for example a request for a customized setting of at least one parameter of a building function, to the processing means 400 of the system. The processing means 400 of the system issue a command for managing a control parameter of the relevant building function commanding, by means of control software, an actuator 120 associated with such function and preferably return to the individual, through the interface 300, the confirmation that the set parameter has been updated.

It should be noted that the embodiment proposed for the present invention in the foregoing discussion of the present invention is purely illustrative and non-limiting. A person skilled in the art may easily implement the present invention in different embodiments which do not depart from the principles outlined herein and are therefore included in the present patent.

This applies in particular to the possibility of extending the present invention to areas of buildings, such as extended regions including a plurality of separate buildings within their boundaries, for example a university campus.

Naturally, without altering the principle of the invention, the embodiments and the details of implementation may vary widely with respect to that which is described and illustrated purely by way of non-limiting example, without thereby departing from the scope of protection of the invention defined by the accompanying claims.

1. An interactive building management system, comprising:
a positioning system adapted to determine the position of individuals within a building, including a plurality of receivers installed in the building and forming a seamless coverage area of the building, each of which is adapted to receive at least one identification signal from a personal portable electronic device associated with a respective individual who frequents the building, and a positioning engine arranged to determine the position of said personal portable electronic device on a predefined building map based on data received by at least one of said plurality of receivers said plurality of receivers being arranged in the building in such a way as to ensure reception of said identification signal from said personal portable electronic device by at least one receiver when said personal portable electronic device is located in a building environment or in proximity to an access or communication gate among building environments;
a user interface system comprising a computerized data collection and processing environment implemented as an application residing on said personal portable electronic device such device being programmed to broadcast said identification signal according to a predetermined radio signal packet adapted to be received by said plurality of receivers,
the user interface system being further arranged to acquire requests for customization of the functions of the building by individuals located in the building or in proximity thereof,
a database system of individuals located within the building, arranged for storing positioning time data of individuals who frequent the building and requests for customization building functions by said individuals as a function of time;
a building function control system, arranged to command a plurality of actuators of building systems arranged in different environments; and
processing means arranged to:
communicate with said positioning system for receiving positioning data of at least one individual frequenting the building;
communicate with said user interface system to receive customization requests of at least one function of the building by said individual;
connect to said database system and acquire positioning data of individuals who frequent the building as a function of time and a history of requests for customization of the functions of the building by said individuals as a function of time; and
transmit to said building function control system building function control programs according to the history of customization requests, or signals indicative of the control of building functions according to the immediate customization requests received from the individuals who frequent the building.

2. The system of claim 1, wherein said processing means are arranged also for:
acquiring, from said database system, identification data of a located individual and;
transmitting to said building function control system a signal of consent to, or prohibition from, access to the building by said individual, intended to command an actuator associated with an access gate to the building or to a building environment.

3. The system of claim 1, wherein said user interface system is arranged to register an individual in the interactive building management system.

4. The system of claim 1, wherein the control of the building functions comprises access to or booking of facilities, rooms or services of the building, or reservation of participation at events within the building.

5. The system of the claim 1, wherein said processing means are arranged to transmit to said building function control system signals indicative of the control of building functions shared by a plurality of individuals according to instant customization requests received from each individual, according to an average value of said requests.

6. The system of claim 1, wherein said processing means are arranged to monitor presence of the located individuals in predetermined environments of the building.

7. The system of claim 1, wherein said processing means are arranged to acquire environmental sensing data through environmental sensors installed in the building.

8. The system of claim 1, wherein said plurality of receivers comprises receiving devices adapted to receive an identification signal from a personal portable electronic device broadcast with a Bluetooth low energy communication protocol.

9. The system of claim 1, wherein said building functions comprise heating, ventilation, air conditioning and lighting of the building environments.
